(19) United States
(12) Patent Application Publication
(10) Pub. No.: US 2026/0332346 A1
(43) Pub. Date: Oct. 22, 2026

(54) CROSS -COMPONENT CARRIER (CC) TRANSMISSION CONFIGURATION INDICATOR (TCI) INDICATION

(71) Applicant: QUALCOMM Incorporated, San Diego, CA (US)

(72) Inventors: Tianyang BAI, Mountain View, CA (US); Yan ZHOU, San Diego, CA (US); Ruiming ZHENG, Beijing (CN); Junyi LI, Greentown, PA (US); Tao LUO, San Diego, CA (US)

(21) Appl. No.: 19/112,205

(22) PCT Filed: Dec. 3, 2022
(86) PCT No.: PCT/CN2022/136406

§ 371 Date: Mar. 14, 2025

(51) Int. Cl. H04L 5/00; H04W 72/232

(52) U.S. Cl. CPC H04L 5/0053; H04W 72/232

(57) ABSTRACT

Certain aspects of the present disclosure provide a method for wireless communications by a user equipment (UE). The UE receives a first signaling configuring the UE with transmission configuration indicator (TCI) states for a group of component carriers (CCs) where each CC of the group is associated with one of a plurality of transmission reception point (TRP) modes. The UE receives an indication to activate one of the TCI states for a first CC of the group. The UE applies the activated TCI state for the first CC and one or more CCs of remaining CCs of the group based on at least one of: a type of the indication or a TRP mode associated with the remaining CCs of the group. The remaining CCs of the group comprise the CCs other than the first CC.

### BACKGROUND

### Field of the Disclosure

Aspects of the present disclosure relate to wireless communications, and more particularly, to techniques for managing activation of transmission configuration indicator (TCI) states for component carriers (CCs) associated with different transmission reception point (TRP) modes.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE), comprising: receiving a first signaling configuring the UE with transmission configuration indicator (TCI) states for a group of component carriers (CCs), wherein each CC of the group is associated with one of a plurality of transmission reception point (TRP) modes; receiving an indication to activate one of the TCI states for a first CC of the group; and applying the activated TCI state for the first CC and one or more CCs of remaining CCs of the group, based on at least one of: a type of the indication or a TRP mode associated with the remaining CCs of the group, wherein the remaining CCs of the group comprise the CCs other than the first CC.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts transmission configuration indicator (TCI) activation for one component carrier (CC) of a group of CCs associated with a same CC list.

FIG. 6 depicts a process flow for communications in a network between a UE and a network entity.

FIG. 7 depicts TCI activation for a CC associated with a single transmission reception point (sTRP) mode of a group of CCs associated with a same CC list.

FIG. 8 depicts TCI activation for a CC associated with a multiple downlink control information (mDCI) mTRP mode of a group of CCs associated with a same CC list.

FIG. 9 depicts example first translation rule from mDCI mTRP mode medium access control (MAC)—control element (CE) to sTRP mode MAC-CE and single downlink control information (sDCI) mTRP mode MAC-CE.

FIG. 10 depicts example second translation rule from mDCI mTRP mode MAC-CE to sTRP mode MAC-CE and sDCI mTRP mode MAC-CE.

FIG. 11 depicts TCI activation for a CC associated with a sDCI mTRP mode of a group of CCs associated with a same CC list.

FIG. 12 depicts a method for wireless communications by a UE.

FIG. 13 depicts an example communications device.

### DETAILED DESCRIPTION

Aspects of the present disclosure provide apparatuses, methods, processing systems, and computer-readable mediums for managing activation of transmission configuration indicator (TCI) states for different component carriers (CCs) associated with different transmission reception point (TRP) modes within a preconfigured CC list.

In some cases, a TCI state is used to indicate a Quasi Co-Location (QCL) relationship between one or more downlink reference signals (DL RSs) and DMRS antenna port(s) for a physical downlink control channel (PDCCH) and a physical downlink shared channel (PDSCH). Two antenna ports are considered to be Quasi Co-Located (QCL'ed) when the properties of a channel over which a symbol on one antenna port is conveyed can be inferred from the channel over which a symbol on the other antenna port is conveyed.

A wireless system, such as a new radio (NR) system, supports carrier aggregation using multiple CCs. When a user equipment (UE) is configured with multiple CCs of the preconfigured CC list, a single medium access control (MAC) control element (CE) may be used to activate TCI states in the multiple CCs within the preconfigured CC list. For example, the MAC-CE TCI state activation to a first CC of the preconfigured CC list is applicable to all the other CCs in the preconfigured CC list, when at least each CC within the preconfigured CC list is associated with a single transmission reception point (sTRP).

However, in some cases, when the different CCs within the preconfigured CC list are associated with different TRP modes such as sTRP mode, multiple downlink control information (mDCI) mTRP mode, and/or a single DCI (sDCI) mTRP mode, the MAC-CE indicating the TCI state activation for the first CC (e.g., associated with the sTRP) within the preconfigured CC list will not be directly applicable to a second CC (e.g., associated with the mTRP) within the same preconfigured CC list.

Techniques proposed herein allow for a single command (e.g., a MAC-CE or DCI) to activate TCI states for multiple CCs associated with different TRP modes within a preconfigured CC list. For example, when the MAC-CE activates a TCI state of a first CC associated with a first TRP mode within the preconfigured CC list, the activated TCI state is applicable for the first CC as well as one or more other CCs within the preconfigured CC list based on a type of the command (i.e., the MAC-CE or the DCI) and/or a TRP mode associated with the other CCs. The techniques proposed herein may enhance system efficiency through a reduction in signaling overhead and reduced power consumption (e.g., by using the single MAC-CE/DCI to activate the TCI states for the multiple CCs).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

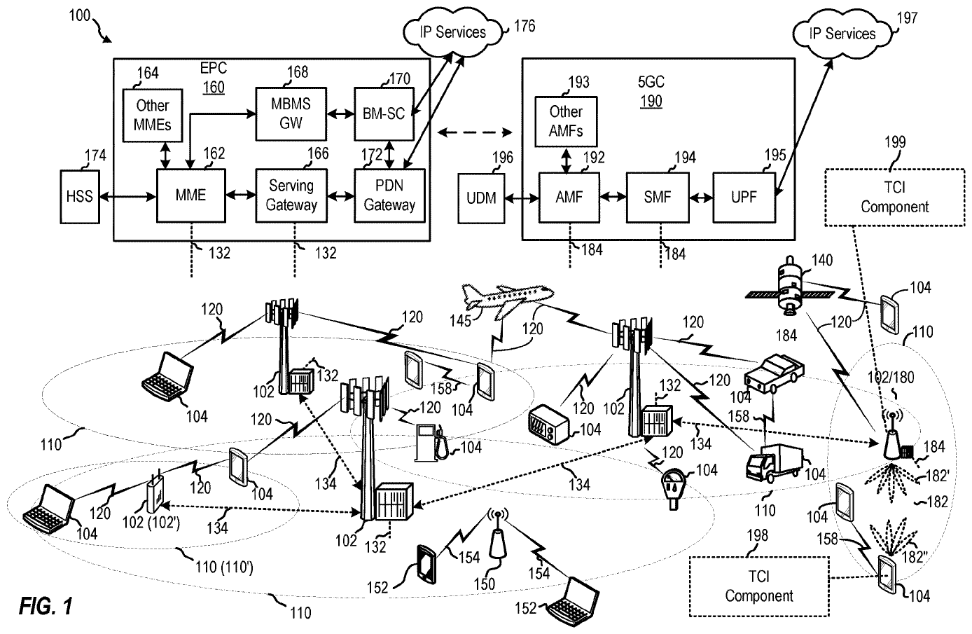

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

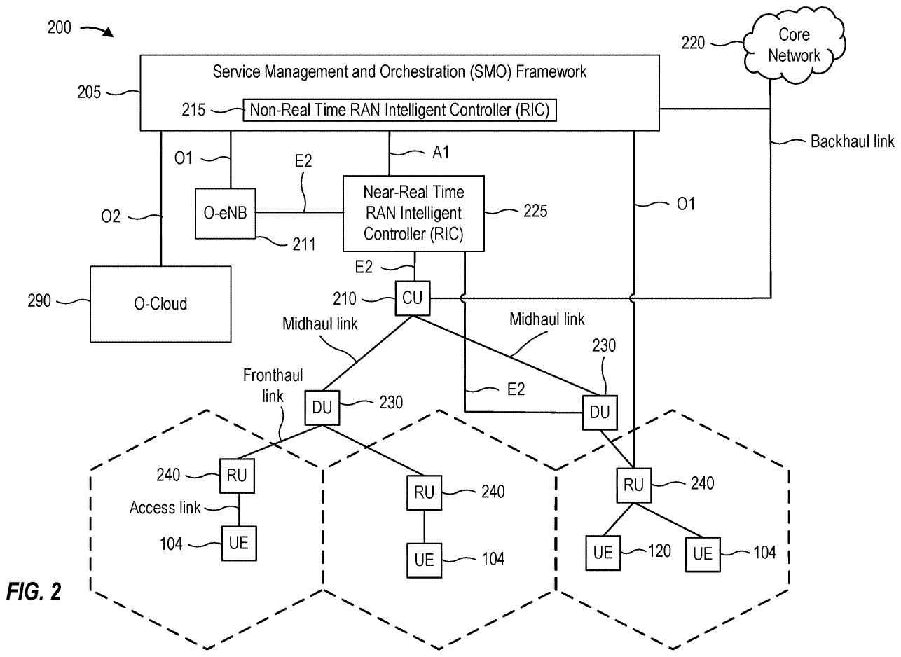

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR 1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mm Wave radio frequency bands (e.g., a mm Wave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

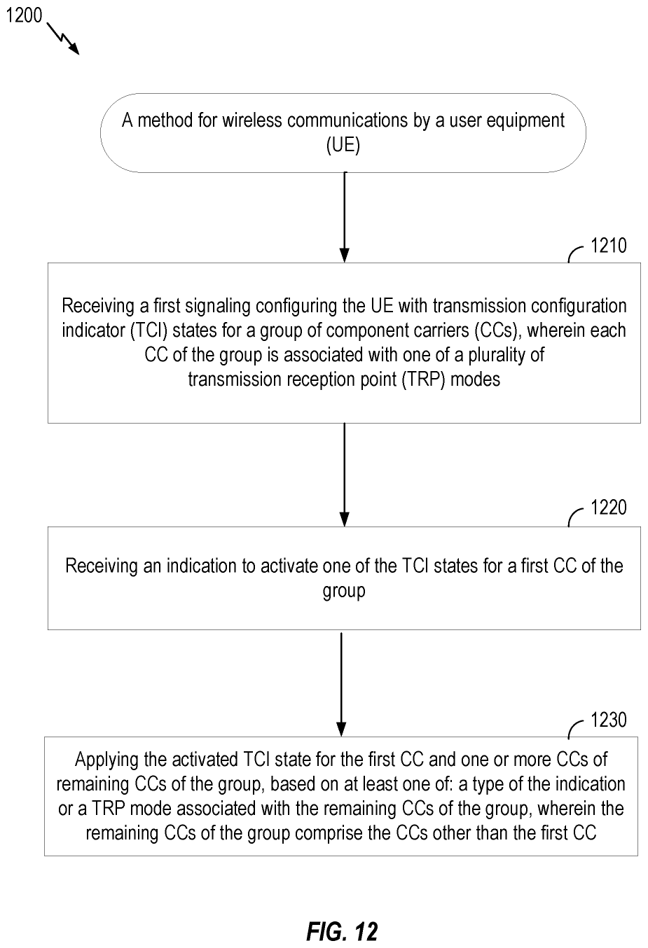

Wireless communication network 100 further includes transmission configuration indicator (TCI) component 198, which may be configured to perform one or more steps of method 1200 of FIG. 12. Wireless communication network 100 further includes TCI component 199, which may be configured to perform one or more steps of method 1200 of FIG. 12.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

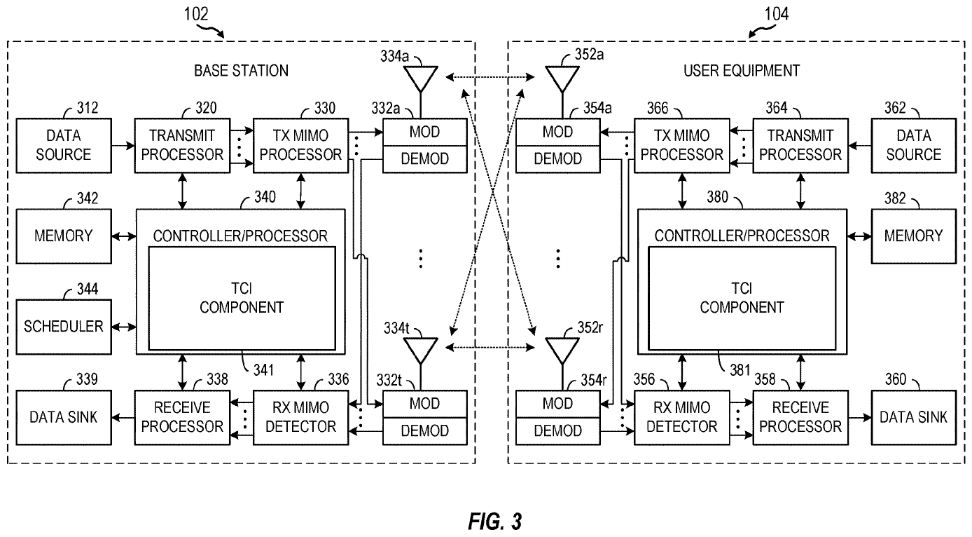

FIG. 3 depicts aspects of an example BS 102 and a UE 104.

Generally, BS 102 includes various processors (e.g., 320, 330, 338, and 340), antennas 334a-t (collectively 334), transceivers 332 a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes TCI component 341, which may be representative of TCI component 199 of FIG. 1. Notably, while depicted as an aspect of controller/processor 340, TCI component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes TCI component 381, which may be representative of TCI component 198 of FIG. 1. Notably, while depicted as an aspect of controller/processor 380, TCI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

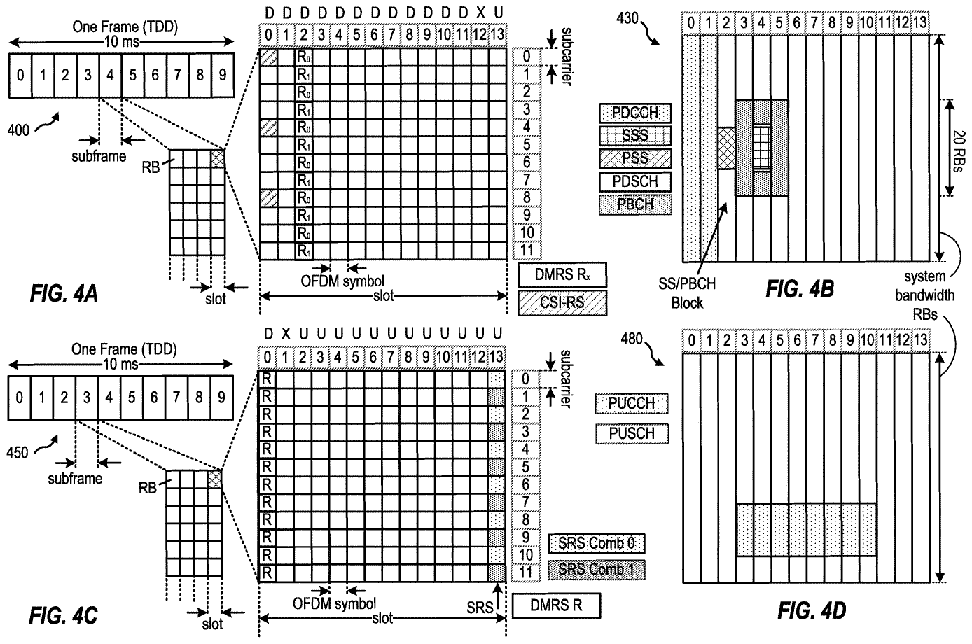

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR 1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Example Transmission Configuration Indicator (TCI) State

In some wireless systems, a transmission configuration indicator (TCI) state is used to indicate a Quasi Co-Location (QCL) relationship between one or more downlink reference signals (DL RSs) and DMRS antenna port(s) for a physical downlink control channel (PDCCH) and a physical downlink shared channel (PDSCH). Two antenna ports are considered to be Quasi Co-Located (QCL'ed) when the properties of a channel over which a symbol on one antenna port is conveyed can be inferred from the channel over which a symbol on the other antenna port is conveyed.

Four types of QCL have been defined in the 5G new radio (NR) standards and are designated as Types A through D. The QCL types are defined as QCL-TypeA, which includes Doppler shift, Doppler spread, average delay, delay spread; QCL-TypeB including Doppler shift and Doppler spread; QCL-TypeC including Doppler shift and average delay; and QCL-TypeD including a spatial receiver (Rx) parameter. When two DL RSs are included in a TCI state, the QCL types will always be different no matter whether the two DL RSs are the same DL RS or are different DL RSs. In some cases, the DL RSs could be a synchronization signal block (SSB) including a synchronization signal SS (e.g., a primary synchronization signal (PSS) and/or a secondary synchronization signal (SSS)) and a physical broadcast channel (PBCH), or a channel-state information reference signal (CSI-RS). Additionally, with certain QCL types, two signal ports are considered to be QCL'ed when the channels share the same property indicated by the QCL type.

When a TCI state is determined for a PDSCH DMRS, it is noted that a user equipment (UE) may be configured with a set of the possible TCI states that are communicated to the UE in a radio resource control (RRC) level message (e.g., a PDSCH-Config message). For example, the RRC level message may be configured with a TCI state that serves to associate one or more DL RSs with a corresponding QCL type. In particular, the UE will receive a media access control (MAC) control element (CE) command to down select a subset of TCI states configured in the RRC message. Additionally, in some cases, the UE may receive downlink control information (DCI) to further select a particular single TCI state from the subset of TCI states.

### Example Cross—Component Carrier (CC) Transmission Configuration Indicator (TCI) Activation/Indication

A wireless system, such as a new radio (NR) system, supports carrier aggregation using multiple component carrier (CCs). In some cases, one or more CCs may be divided into bandwidth parts (BWPs), and one BWP may be active for communications using a CC. In one example, a communication link in the wireless system may support transmissions using multiple CCs (e.g., up to 16 uplink CCs and up to 16 downlink CCs). In some cases, one medium access control (MAC) control element (CE) may be used to configure two or more CCs with two or more different sets of active transmission configuration indicator (TCI) states.

In some cases, each CC is uniquely identified and configured for physical channel and reference signal transmissions. For example, a beam selection may be indicated to a user equipment (UE) via a MAC-CE for each downlink and uplink CC. The configuration of each CC may lead to increased signaling overhead in the wireless system.

In some cases, when the UE is configured with multiple CCs, a relatively large number of MAC-CEs (e.g., up to 16 MAC-CEs, one for each of the up to 16 CCs) may be used to select different TCI state identifiers (ID) in every CC (e.g., in downlink NR-NR carrier aggregation). The use of this number of the MAC-CEs may lead to an increase in signaling overhead between the UE and a network entity. In order to reduce the number of MAC-CEs used for conveying the active sets of TCI states in each CC configured for communications between the network entity and the UE, a single MAC-CE command may be used to activate two or more different sets of active TCI states for a number of CCs/BWPs for which the TCI states are active (e.g., for multiple CCs/BWPs). For example, a first set of activated TCI states may be selected to be associated with a first group of one or more CCs, and a second set of activated TCI states may be selected to be associated with a second group of one or more CCs.

In some cases, the single MAC-CE may be used to activate different sets of active TCI states for data communications (e.g., a physical downlink shared channel (PDSCH) or a physical uplink shared channel (PUSCH)) in groups of different CCs within a preconfigured CC list. This is in contrast to the use of the multiple MAC-CEs, where each MAC-CE is used to select the sets of active TCI states in the active BWP of a corresponding individual CC (e.g., in downlink NR-NR carrier aggregation), which may result in the increased signaling overhead between the UE and the network entity.

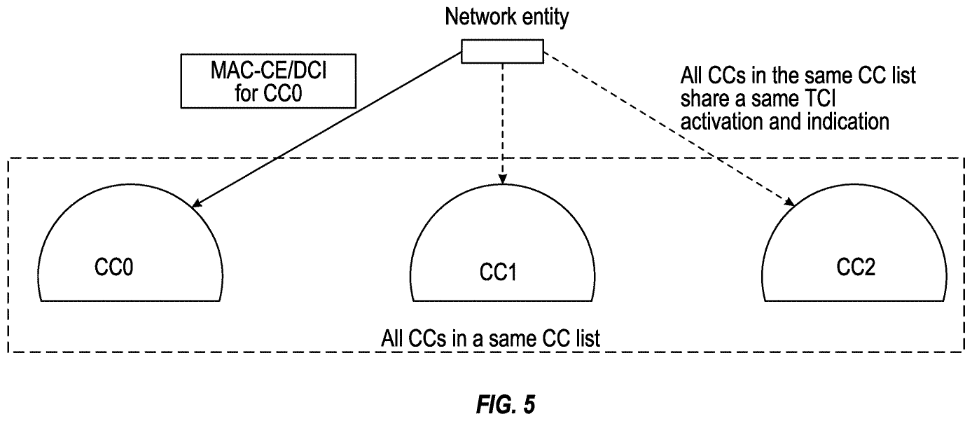

For example, as illustrated in FIG. 5, a network entity sends a MAC-CE indicating TCI state activation to a first CC (CC0) of a preconfigured CC list, and the TCI state activation is applicable to all other CCs. That is, the MAC-CE TCI activation to the first CC is applicable to all the other CCs in the preconfigured CC list including the first CC. In some cases, not only the MAC-CE TCI state activation, but downlink control information (DCI) indication for a unified TCI state activation is also applicable to all the other CCs in the preconfigured CC list.

Currently, a unified TCI state activation framework (e.g., based on the single MAC-CE or the DCI to activate the different active TCI states for the different CCs) is applicable for a single transmission reception point (TRP) mode case where each CC within the preconfigured CC list is associated with a single TRP.

However, in some cases, when different CCs within the preconfigured CC list are associated with different TRP modes such as sTRP mode, multiple DCI (mDCI) mTRP mode, and/or a single DCI (sDCI) mTRP mode, the current unified TCI state activation framework will not be applicable due to several issues. For example, since there are different MAC-CE formats defined for sTRP CCs, mTRP mDCI CCs, and mTRP sDCI CCs, a MAC-CE indicating TCI state activation for a first CC (e.g., associated with the sTRP) within the preconfigured CC list will not be directly applicable to a second CC (e.g., associated with the mTRP) within the same preconfigured CC list. In another example, a conventional MAC-CE may not contain sufficient information to activate TCI codepoints for mTRPs.

Accordingly, there is a need for an improved unified TCI state activation framework, which is applicable for the mTRP cases where the different CCs within the preconfigured CC list are associated with the different TRP modes.

### Aspects Related to Transmission Configuration Indicator (TCI) Activation/Indication for Component Carriers (CCs) Associated with Different Transmission Reception Point (TRP) Modes

Aspects of the present disclosure provide apparatuses, methods, processing systems, and computer-readable mediums for managing activation of transmission configuration indicator (TCI) states for different component carriers (CCs) associated with different transmission reception point (TRP) modes within a preconfigured CC list.

For example, techniques proposed herein allow for a single command (e.g., a medium access control (MAC)—control element (CE) or downlink control information (DCI)) to activate the TCI states for the multiple CCs associated with the different TRP modes within the preconfigured CC list. For example, when the MAC-CE activates a TCI state of a first CC associated with a first TRP mode within the preconfigured CC list, the activated TCI state is applicable for the first CC as well as one or more other CCs within the preconfigured CC list based on a type of the command (i.e., the MAC-CE or the DCI) and/or a TRP mode associated with the other CCs.

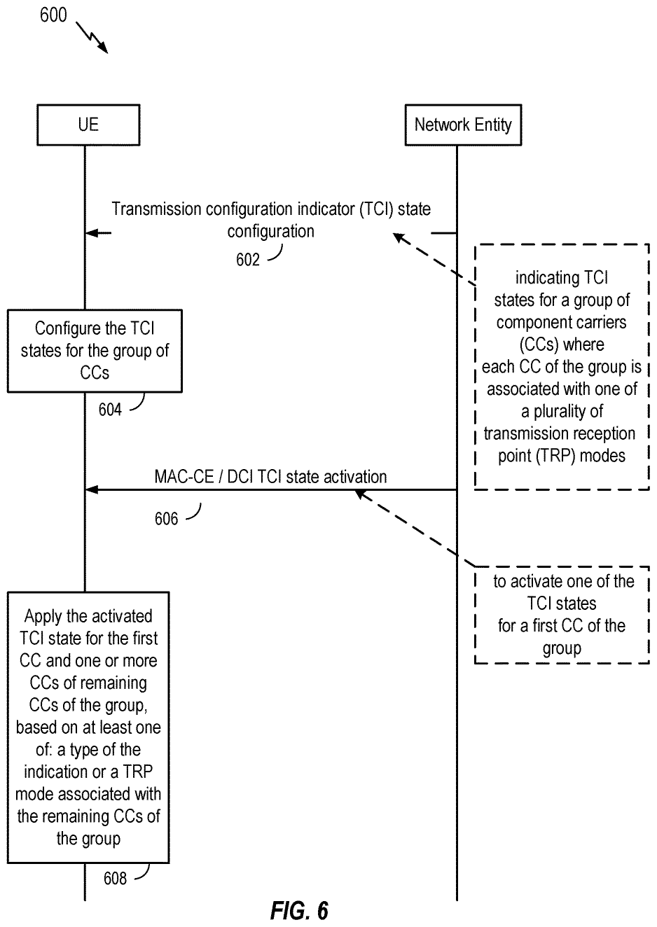

The techniques proposed herein may enhance system efficiency through a reduction in signaling overhead and reduced power consumption (e.g., by using the single MAC-CE/DCI to activate the TCI states for the multiple CCs). The techniques proposed herein may be further understood with reference to FIGS. 6-12.

FIG. 6 depicts a process flow for communications in a network between between a UE (e.g., such as UE 104 in wireless communication network 100 of FIG. 1) and a network entity (e.g., such as BS 102 in wireless communication network 100 of FIG. 1).

At 602, the network entity sends a TCI state configuration indicating TCI states for a group of CCs (e.g., associated with a same CC list) to the UE. Each CC of the group is associated with one of a plurality of TRP modes. The plurality of TRP modes may include a single TRP (sTRP) mode and a multiple TRP (mTRP) mode. The mTRP mode may correspond to a multiple downlink control information (mDCI) mTRP mode. The m TRP mode may also correspond to a single DCI (sDCI) mTRP mode.

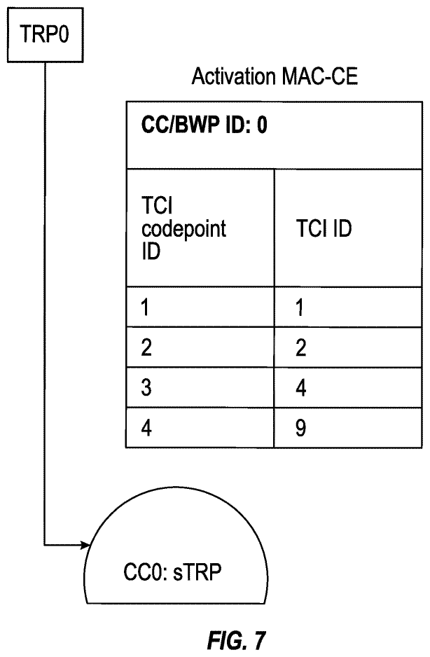

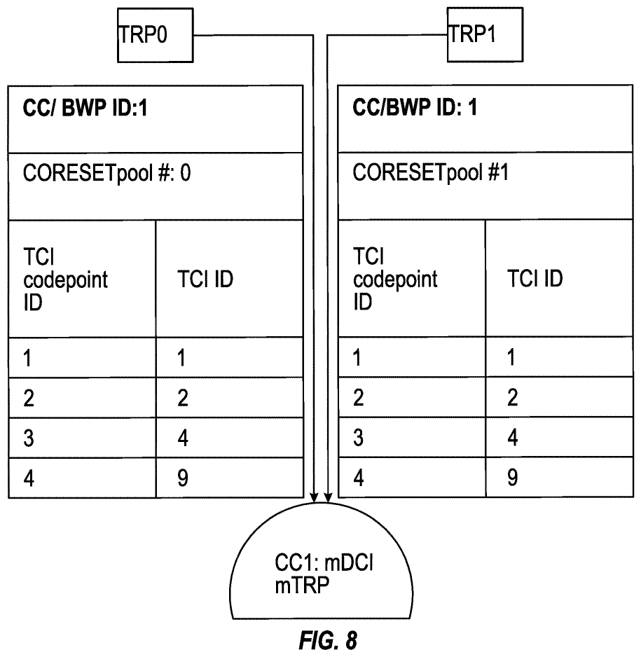

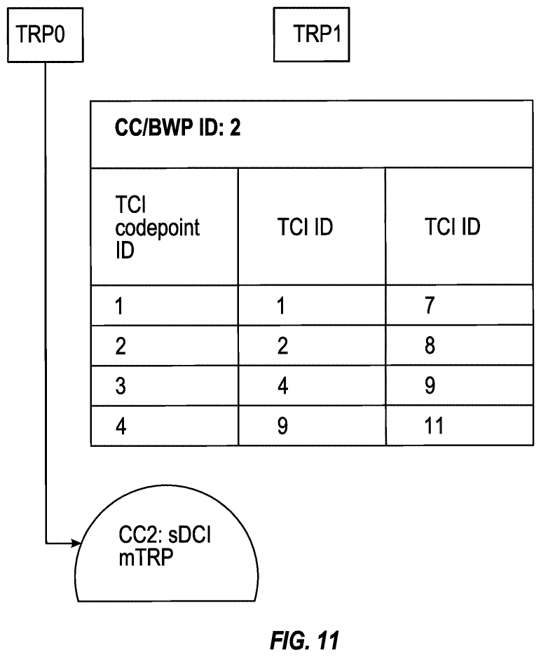

In one aspect, at least one CC of the group is associated with the sTRP mode. For example, as illustrated in FIG. 7, CC0 is associated with TRP0. In another aspect, at least one CC of the group is associated with the mDCI mTRP mode. For example, as illustrated in FIG. 8, CC1 is associated with TRPO and TRP1. CC1 receives DCI from both TRPO and TRP1. In another aspect, at least one CC of the group is associated with the sDCI mTRP mode. For example, as illustrated in FIG. 11, CC2 is associated with TRPO and TRP1. CC2 receives DCI from TRP0.

Referring back to FIG. 6, at 604, the UE configures the TCI state configuration indicating the TCI states for the group of CCs.

At 606, the network entity sends an indication to the UE to activate one of the TCI states for a first CC of the group. The first CC may be a reference CC. In one example, the network entity sends to the UE a medium access control (MAC)—control element (CE) carrying the indication to activate the one of the TCI states for the first CC of the group. In another example, the network entity sends to the UE DCI carrying the indication to activate the one of the TCI states for the first CC of the group.

At 608, the UE applies the activated TCI state for the first CC, and for one or more CCs of remaining CCs of the group based on at least one of: a type of the indication or a TRP mode associated with the remaining CCs of the group. The remaining CCs of the group include the CCs other than the first CC. For example, the UE may apply the activated TCI state for the one or more CCs of the remaining CCs of the group, based on the type of the indication. In another example, the UE may apply the activated TCI state for the one or more CCs of the remaining CCs of the group, based on the TRP mode associated with the remaining CCs of the group. In another example, the UE may apply the activated TCI state for the one or more CCs of the remaining CCs of the group, based on the type of the indication and the TRP mode associated with the remaining CCs of the group.

In certain aspects, there may be some restrictions on CCs that can be within the group and/or the first CC of the group. For instance, all CCs of the group may be associated with a same TRP mode of the plurality of TRP modes. That is, only CCs with the same TRP mode can be configured in the group. For example, when the group has a CC associated with the sTRP mode (e.g., as illustrated in FIG. 7), all other CCs in the group are also associated with the sTRP mode.

In certain aspects, different CCs of the group are associated with different TRP modes of the plurality of TRP modes. For example, the different CCs associated with the different TRP modes are allowed in the group when at least the first CC (e.g., indicated to the UE via the MAC-CE) is associated with the mTRP mode.

In certain aspects, the first CC (e.g., indicated to the UE via the MAC-CE) is associated with the sTRP mode. In such cases, the UE applies the activated TCI state for the first CC, and the one or more CCs of the remaining CCs of the group associated with the sTRP mode. For example, the MAC-CE for the first CC associated with the sTRP mode only applies to the sTRP CCs in the group.

In certain aspects, the MAC-CE includes one or more configurations for the plurality of TRP modes, and each CC of the group is associated with a configuration of a corresponding TRP mode of the plurality of TRP modes. For example, a single MAC-CE may contain the configurations for the multiple TRP modes, and each CC may follow the configuration of the corresponding TRP mode.

In certain aspects, the MAC-CE (e.g., indicating the first CC associated with the mDCI mTRP mode to the UE) may be associated with at least one control resource set (CORESET) pool identification (ID). In such cases, the UE applies the activated TCI state for the first CC, and the one or more CCs of the remaining CCs of the group associated with the sTRP mode. For example, the mDCI mTRP mode MAC-CE associated with the at least one CORESET pool ID is applicable to the sTRP mode CC (e.g., for the mDCI mTRP to the sTRP translation rule).

In certain aspects, the at least one CORESET pool ID is predefined. For example, the at least one CORESET pool ID may be predefined as a smallest ID.

In certain aspects, the UE receives another signaling configuring the UE with the at least one CORESET pool ID. For example, the at least one CORESET pool ID may be configured by the network entity.

In certain aspects, the UE receives the indication to activate a first TCI state of the TCI states for the first CC of the group. The first TCI state activated from a first CORESET pool ID associated with the first CC corresponds to a first TCI state in a first TCI codepoint associated with the one or more CCs of the remaining CCs of the group associated with the sTRP mode. For example, i-th TCI activated from a CORESET pool #m in the mDCI mTRP CC corresponds to i-th TCI in m-th TCI codepoint in the sDCI mTRP (i.e., one to one mapping).

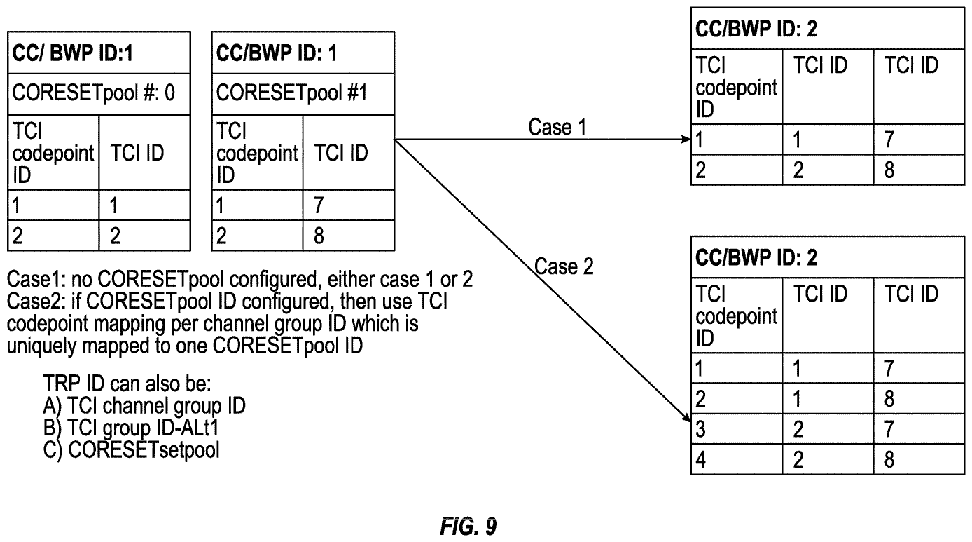

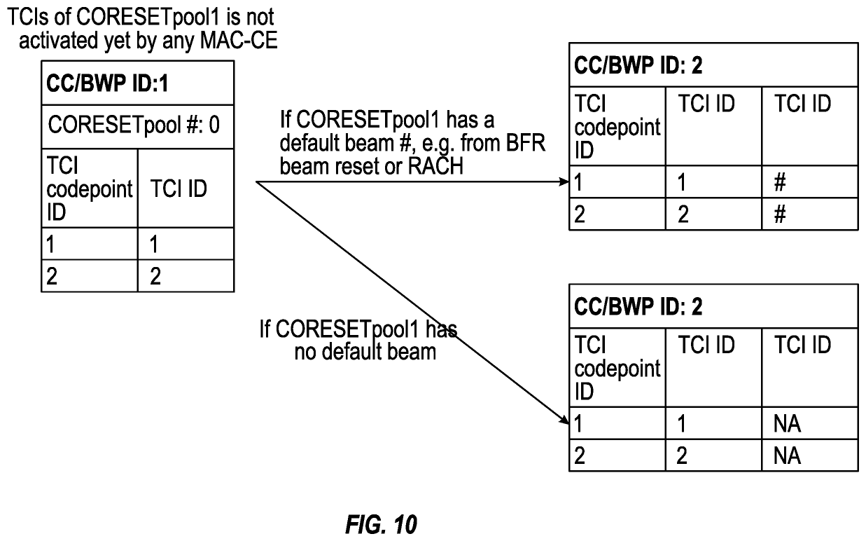

In certain aspects, a TCI codepoint list of CCs of the group associated with the sDCI mTRP mode corresponds to a permutation of all activated TCI states from all CORESET pool IDs of CCs of the group associated with the mDCI mTRP mode. For example, as illustrated in FIG. 9 and FIG. 10, the sDCI mTRP TCI codepoint list corresponds to a permutation of all activated TCIs from all CORESET pools in the mDCI mTRP (i.e., one to N mapping).

In certain aspects, the MAC-CE (e.g., indicating the first CC associated with the sDCI mTRP mode to the UE) is associated with at least one order ID. In such cases, the UE applies the activated TCI state for the first CC, and the one or more CCs of the remaining CCs of the group associated with the sTRP mode. For example, in a sTRP mode case, a TCI codepoint may contain multiple TCIs, and the TCIs of the TCI codepoint may be labled based on their order within the TCI codepoint (e.g., a first TCI of a third TCI codepoint).

In certain aspects, one or more activated TCI states associated with the at least one order ID for the first CC are applicable to the one or more CCs of the remaining CCs of the group associated with the sTRP mode. For example, only activated TCIs associated with a predefined order ID are applicable to the sTRP mode CC (e.g., for the sDCI mTRP mode to the sTRP mode translation rule)

In certain aspects, the at least one order ID is predefined as a first TCI state. In certain aspects, the UE receives another signaling configuring the UE with the at least one order ID. For example, the at least one order ID may be configured by the network entity.

In certain aspects, the UE receives the indication to activate a first TCI state of the TCI states for the first CC. The first TCI state in a first TCI codepoint associated with the first CC corresponds to a first TCI state activated from a predefined CORESET pool ID associated with the one or more CCs of the remaining CCs of the group associated with the mDCI mTRP mode. For example, i-th TCI in m-th TCI codepoint in the sDCI m TRP CC corresponds to i-th TCI activated from a CORESET pool #m in the mDCI mTRP CC.

In certain aspects, when the DCI carries the indication, the sTRP CC and the sDCI mTRP CC share a same DCI format.

In certain aspects, the first CC is associated with the sTRP mode and/or the sDCI mTRP mode. In such cases, the UE applies the activated TCI state for the first CC, and the one or more CCs of the remaining CCs of the group associated with the sTRP mode and/or the sDCI mTRP mode. For example, the TCI indication for the sTRP CC or the sDCI mTRP CC applies to the sTRP and sDCI mTRP CCs in the group.

In certain aspects, the first CC is associated with the mDCI mTRP mode. In such cases, the UE applies the activated TCI state for the first CC, and the one or more CCs of the remaining CCs of the group associated with the mDCI mTRP mode. For example, the TCI indication for the mDCI mTRP CC applies to the mDCI mTRP (and the sTRP) CCs in the group.

In certain aspects, the UE receives the indication to activate a first TCI codepoint for the first CC associated with at least one of: the sTRP mode or the sDCI mTRP mode. In such cases, the UE selects and activates a first TCI codepoint for all CORESET pool IDs for the one or more CCs of the remaining CCs of the group associated with the mDCI mTRP mode. For example, when the DCI from the sTRP/sDCI mTRP indicates i-th TCI codepoint, then in mDCI mTRP CC, i-th TCI codepoint may be selected for all CORESET pool IDs (e.g., for the sTRP/sDCI mTRP to the mDCI mTRP translation rule).

In certain aspects, the DCI is associated with a first CORESET pool identification ID, and the first CORESET pool ID is smaller than other CORESET pool IDs. In such cases, the UE receives the DCI carrying the indication to activate one of the TCI states for the first CC associated with the mDCI mTRP mode. The UE then applies the activated TCI state for the first CC, and the one or more CCs of the remaining CCs of the group associated with the sTRP mode. For example, the DCI from a predefined CORESET pool is applicable to the sTRP CC in the group (e.g., for the mDCI mTRP to the sTRP translation rule). In another example, the DCI associated with a CORESET pool #0 (e.g., smallest CORESET pool ID) is applicable to the sTRP CC in the group. The DCI with a CORESET pool #1 is applicable to the mDCI mTRP CC in the group, but is not applicable to the sTRP CC in the group.

In certain aspects, the DCI is associated with at least one CORESET pool ID. In such cases, when the UE receives the DCI carrying the indication to activate one of the TCI states for the first CC associated with the mDCI mTRP mode, the UE then applies the activated TCI state for the first CC, and the one or more CCs of the remaining CCs of the group associated with the sDCI m TRP mode. For example, the DCI from a predefined CORESET pool is applicable to the sDCI mTRP CC in the group (e.g., for the mDCI mTRP to the sDCI mTRP translation rule).

In certain aspects, the DCI is associated with at least one CORESET pool ID. In such cases, the UE receives the DCI carrying the indication of a TCI codepoint for the first CC associated with the mDCI mTRP mode. The TCI codepoint for the first CC corresponds to all TCI codepoints from each CORESET pool ID of the one or more CCs of the remaining CCs of the group associated with the mDCI mTRP mode. For example, the indicated TCI codepoint in the sDCI mTRP CC contains all the indicated TCIs from each CORESET pool in the mDCI mTRP CC in the group (e.g., for the mDCI mTRP to the sDCI mTRP translation rule).

FIG. 12 depicts example method 1200 for wireless communication. The method 1200 may be performed, for example, by a UE (e.g., such as UE 104 in wireless communication network 100 of FIG. 1). The method 1200 is implemented as software components that are executed and run on one or more processors (e.g., controller/processor 380 of FIG. 3). Further, transmission and reception of signals by the UE in the method 1200 may be enabled, for example, by one or more antennas (e.g., antennas 352 of FIG. 3). In certain aspects, the transmission and/or reception of signals by the UE are implemented via a bus interface of one or more processors (e.g., the controller/processor 380) obtaining and/or outputting signals.

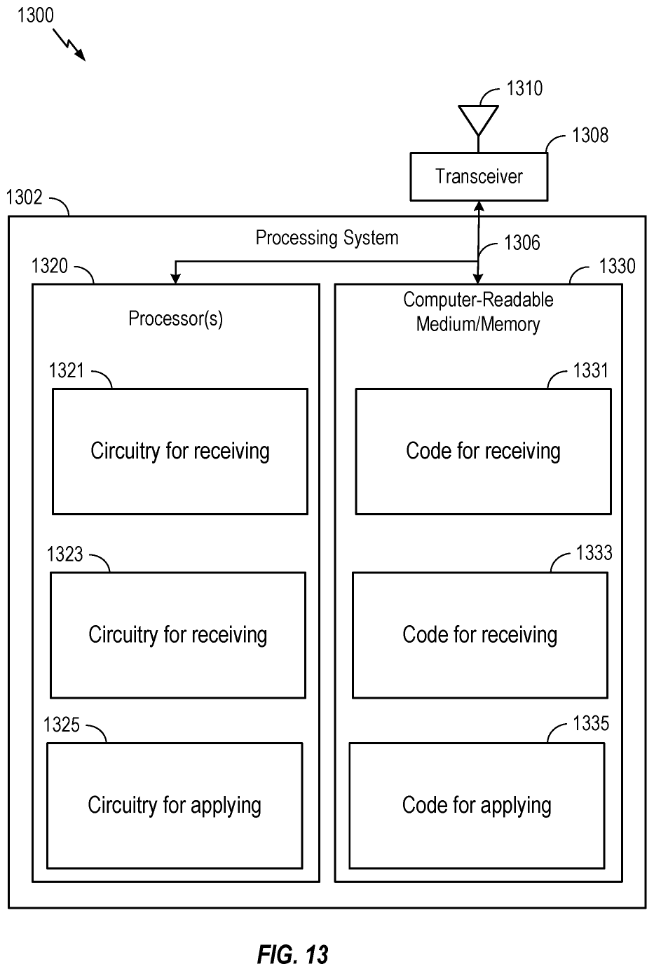

The method 1200 begin, at 1210, by receiving a first signaling configuring the UE with TCI states for a group of CCs where each CC of the group is associated with one of a plurality of TRP modes. For example, the UE may receive the first signaling configuring the UE with the TCI states for the group of CCs, using antenna(s) and/or receiver/transceiver components of UE 104 shown in FIG. 1 or FIG. 3 and/or of the apparatus shown in FIG. 13.

At 1220, the UE receives an indication to activate one of the TCI states for a first CC of the group. For example, the UE may receive the indication to activate one of the TCI states for the first CC of the group, using antenna(s) and/or receiver/transceiver components of UE 104 shown in FIG. 1 or FIG. 3 and/or of the apparatus shown in FIG. 13.

At 1230, the UE applies the activated TCI state for the first CC and one or more CCs of remaining CCs of the group, based on at least one of: a type of the indication or a TRP mode associated with the remaining CCs of the group. The remaining CCs of the group comprise the CCs other than the first CC. For example, the UE may apply the activated TCI state for the first CC and the one or more CCs of the remaining CCs of the group, using a processor, antenna(s) and/or transceiver components of UE 104 shown in FIG. 1 or FIG. 3 and/or of the apparatus shown in FIG. 13.

Note that FIG. 12 is just one example of a method, and other methods including fewer, additional, or alternative steps are possible consistent with this disclosure.

### Example Communications Device

FIG. 13 depicts aspects of an example communications device 1300. In some aspects, the communications device 1300 is a user equipment (UE), such as UE 104 described above with respect to FIGS. 1 and 3. In some aspects, the communications device 1300 may be a network entity, such as BS 102 of FIGS. 1 and 3, or a disaggregated BS as discussed with respect to FIG. 2.

The communications device 1300 includes a processing system 1302 coupled to a transceiver 1308 (e.g., a transmitter and/or a receiver). In some aspects (e.g., when the communications device 1300 is a network entity), the processing system 1302 may be coupled to a network interface that is configured to obtain and send signals for the communications device 1300 via communication link(s), such as a backhaul link, midhaul link, and/or fronthaul link as described herein, such as with respect to FIG. 2. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 358, transmit processor 364, TX MIMO processor 366, and/or controller/processor 380, as described with respect to FIG. 3. In various aspects, one or more processors 1320 may be representative of one or more of receive processor 338, transmit processor 320, TX MIMO processor 330, and/or controller/processor 340, as described with respect to FIG. 3. The one or more processors 1320 are coupled to a computer-readable medium/memory 1330 via a bus 1306. In certain aspects, the computer-readable medium/memory 1330 is configured to store instructions (e.g., computer-executable code) that when executed by the one or more processors 1320, cause the one or more processors 1320 to perform: the method 1200 described with respect to FIG. 12, or any aspect related to it. Note that reference to a processor performing a function of the communications device 1300 may include the one or more processors 1320 performing that function of the communications device 1300.

In the depicted example, the computer-readable medium/memory 1330 stores code (e.g., executable instructions), such as code for receiving 1331, code for receiving 1333, and code for applying 1335. Processing of the code for receiving 1331, the code for receiving 1333, and the code for applying 1335 may cause the communications device 1300 to perform: the method 1200 described with respect to FIG. 12, or any aspect related to it.

The one or more processors 1320 include circuitry configured to implement (e.g., execute) the code stored in the computer-readable medium/memory 1330, including circuitry such as circuitry for receiving 1321, circuitry for receiving 1323 and circuitry for applying 1325. Processing with the circuitry for receiving 1321, the circuitry for receiving 1323 and the circuitry for applying 1325 may cause the communications device 1300 to perform: the method 1200 described with respect to FIG. 12, or any aspect related to it.

Various components of the communications device 1300 may provide means for performing: the method 1200 described with respect to FIG. 12, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1308 and the antenna 1310 of the communications device 1300 in FIG. 13. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1308 and the antenna 1310 of the communications device 1300 in FIG. 13.

### EXAMPLE CLAUSES

Implementation examples are described in the following numbered clauses:
Clause 1: A method for wireless communications by a user equipment (UE), comprising: receiving a first signaling configuring the UE with transmission configuration indicator (TCI) states for a group of component carriers (CCs), wherein each CC of the group is associated with one of a plurality of transmission reception point (TRP) modes; receiving an indication to activate one of the TCI states for a first CC of the group; and applying the activated TCI state for the first CC and one or more CCs of remaining CCs of the group, based on at least one of: a type of the indication or a TRP mode associated with the remaining CCs of the group, wherein the remaining CCs of the group comprise the CCs other than the first CC.
Clause 2: The method alone or in combination with the first clause, wherein: the indication is included in a medium access control (MAC)—control element (CE); the plurality of TRP modes comprise a single TRP (sTRP) mode and a multiple TRP (mTRP) mode; and the mTRP mode corresponds to a multiple downlink control information (mDCI) mTRP mode or a single DCI (sDCI) mTRP mode.
Clause 3: The method alone or in combination with the second clause, wherein all CCs of the group are associated with a same TRP mode of the plurality of TRP modes.
Clause 4: The method alone or in combination with the second clause, wherein: different CCs of the group are associated with different TRP modes of the plurality of TRP modes; and the first CC is associated with the mTRP mode.
Clause 5: The method alone or in combination with the second clause, wherein: the first CC is associated with the sTRP mode; and the applying further comprises applying the activated TCI state for the one or more CCs of the remaining CCs of the group associated with the sTRP mode.
Clause 6: The method alone or in combination with the second clause, wherein: the MAC-CE comprises one or more configurations for the plurality of TRP modes; and each CC of the group is associated with a configuration of a corresponding TRP mode of the plurality of TRP modes.
Clause 7: The method alone or in combination with the second clause, wherein the first CC is associated with the mDCI mTRP mode.
Clause 8: The method alone or in combination with the seventh clause, wherein the MAC-CE is associated with at least one control resource set (CORESET) pool identification (ID).
Clause 9: The method alone or in combination with the eighth clause, wherein the applying further comprises applying the activated TCI state for the one or more CCs of the remaining CCs of the group associated with the sTRP mode, when the MAC CE is associated with the at least one CORESET pool ID.
Clause 10: The method alone or in combination with the eighth clause, wherein at least one of: the at least one CORESET pool ID is predefined as a smallest ID; or receiving a second signaling configuring the UE with the at least one CORESET pool ID.
Clause 11: The method alone or in combination with the eighth clause, wherein: the receiving further comprises receiving the indication to activate a first TCI state of the TCI states for the first CC of the group; and the first TCI state activated from a first CORESET pool ID associated with the first CC corresponds to a first TCI state in a first TCI codepoint associated with the one or more CCs of the remaining CCs of the group associated with the sTRP mode.
Clause 12: The method alone or in combination with the eighth clause, wherein a TCI codepoint list of CCs of the group associated with the sDCI mTRP mode corresponds to a permutation of all activated TCI states from all CORESET pool IDs of CCs of the group associated with the mDCI mTRP mode.
Clause 13: The method alone or in combination with the second clause, wherein the first CC is associated with the sDCI mTRP mode.
Clause 14: The method alone or in combination with the thirteenth clause, wherein the MAC-CE is associated with at least one predefined order identification (ID).
Clause 15: The method alone or in combination with the fourteenth clause, wherein the applying further comprises applying the activated TCI state for the one or more CCs of the remaining CCs of the group associated with the sTRP mode, when the MAC CE is associated with the at least one order ID.
Clause 16: The method alone or in combination with the fourteenth clause, wherein all activated TCI states associated with the predefined order ID for the first CC are applicable to the one or more CCs of the remaining CCs of the group associated with the sTRP mode.
Clause 17: The method alone or in combination with the fourteenth clause, wherein at least one of: the at least one order ID is predefined as a first TCI state; or receiving a third signaling configuring the UE with the at least one order ID.
Clause 18: The method alone or in combination with the fourteenth clause, wherein: the receiving further comprises receiving the indication to activate a first TCI state of the TCI states for the first CC; and the first TCI state in a first TCI codepoint associated with the first CC corresponds to a first TCI state activated from a predefined CORESET pool ID associated with the one or more CCs of the remaining CCs of the group associated with the mDCI mTRP mode.
Clause 19: The method alone or in combination with the first clause, wherein: the indication is included in downlink control information (DCI); the plurality of TRP modes comprise a single TRP (sTRP) mode and a multiple TRP (mTRP) mode; and the mTRP mode corresponds to a multiple downlink control information (mDCI) mTRP mode or a single DCI (sDCI) mTRP mode.
Clause 20: The method alone or in combination with the nineteenth clause, wherein: the first CC is associated with at least one of: the sTRP mode or the sDCI mTRP mode; and the applying further comprises applying the activated TCI state for the one or more CCs of the remaining CCs of the group associated with at least one of: the sTRP mode or the sDCI mTRP mode.
Clause 21: The method alone or in combination with the nineteenth clause, wherein: the first CC is associated with the mDCI mTRP mode; and the applying further comprises applying the activated TCI state for the one or more CCs of the remaining CCs of the group associated with the mDCI mTRP mode.
Clause 22: The method alone or in combination with the nineteenth clause, wherein: the receiving further comprises receiving the indication to activate a first TCI codepoint for the first CC associated with at least one of: the sTRP mode or the sDCI mTRP mode; and the applying further comprises selecting and activating a first TCI codepoint for all control resource set (CORESET) pool identifications (IDs) for the one or more CCs of the remaining CCs of the group associated with the mDCI mTRP mode.
Clause 23: The method alone or in combination with the nineteenth clause, wherein: the DCI is associated with a first control resource set (CORESET) pool identification (ID), wherein the first CORESET pool ID is smaller than other CORESET pool IDs; the receiving further comprises receiving the DCI carrying the indication to activate one of the TCI states for the first CC associated with the mDCI m TRP mode; and the applying further comprises applying the activated TCI state for the one or more CCs of the remaining CCs of the group associated with the sTRP mode.
Clause 24: The method alone or in combination with the nineteenth clause, wherein: the DCI is associated with at least one control resource set (CORESET) pool identification (ID); the receiving further comprises receiving the DCI carrying the indication to activate one of the TCI states for the first CC associated with the mDCI mTRP mode; and the applying further comprises applying the activated TCI state for the one or more CCs of the remaining CCs of the group associated with the sDCI mTRP mode.
Clause 25: The method alone or in combination with the nineteenth clause, wherein: the receiving further comprises receiving the DCI carrying the indication of a TCI codepoint for the first CC associated with the mDCI mTRP mode; and the TCI codepoint for the first CC corresponds to all TCI codepoints from each CORESET pool identification (ID) of the one or more CCs of the remaining CCs of the group associated with the mDCI mTRP mode.
Clause 26: An apparatus, comprising: a memory comprising executable instructions; and a processor configured to execute the executable instructions and cause the apparatus to perform a method in accordance with any one of Clauses 1-26.
Clause 27: An apparatus, comprising means for performing a method in accordance with any one of Clauses 1-26.
Clause 28: A non-transitory computer-readable medium comprising executable instructions that, when executed by a processor of an apparatus, cause the apparatus to perform a method in accordance with any one of Clauses 1-26.
Clause 29: A computer program product embodied on a computer-readable storage medium comprising code for performing a method in accordance with any one of Clauses 1-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communications, comprising: a memory comprising computer-executable instructions; and a processor configured to execute the computer-executable instructions and cause the UE to:
receive a first signaling configuring the UE with transmission configuration indicator (TCI) states for a group of component carriers (CCs), wherein each CC of the group is associated with one of a plurality of transmission reception point (TRP) modes;
receive an indication to activate one of the TCI states for a first CC of the group; and
apply the activated TCI state for the first CC and one or more CCs of remaining CCs of the group based on at least one of: a type of the indication or a TRP mode associated with the remaining CCs of the group, wherein the remaining CCs of the group comprise the CCs other than the first CC.

2. The UE of claim 1, wherein:
the indication is included in a medium access control (MAC)—control element (CE);
the plurality of TRP modes comprise a single TRP (sTRP) mode and a multiple TRP (mTRP) mode; and
the mTRP mode corresponds to a multiple downlink control information (mDCI) mTRP mode or a single DCI (sDCI) mTRP mode.

3. The UE of claim 2, wherein all CCs of the group are associated with a same TRP mode of the plurality of TRP modes.

4. The UE of claim 2, wherein:
different CCs of the group are associated with different TRP modes of the plurality of TRP modes; and
the first CC is associated with the mTRP mode.

5. The UE of claim 2, wherein:
the first CC is associated with the sTRP mode; and
the apply further comprises apply the activated TCI state for the one or more CCs of the remaining CCs of the group associated with the sTRP mode.

6. The UE of claim 2, wherein:
the MAC-CE comprises one or more configurations for the plurality of TRP modes; and
each CC of the group is associated with a configuration of a corresponding TRP mode of the plurality of TRP modes.

7. The UE of claim 2, wherein the first CC is associated with the mDCI mTRP mode.

8. The UE of claim 7, wherein the MAC-CE is associated with at least one control resource set (CORESET) pool identification (ID).

9. The UE of claim 8, wherein the apply further comprises apply the activated TCI state for the one or more CCs of the remaining CCs of the group associated with the sTRP mode, when the MAC CE is associated with the at least one CORESET pool ID.

10. The UE of claim 8, wherein at least one of:
the at least one CORESET pool ID is predefined as a smallest ID; or
receive a second signaling configuring the UE with the at least one CORESET pool ID.

11. The UE of claim 8, wherein:
the receive further comprises receive the indication to activate a first TCI state of the TCI states for the first CC of the group; and
the first TCI state activated from a first CORESET pool ID associated with the first CC corresponds to a first TCI state in a first TCI codepoint associated with the one or more CCs of the remaining CCs of the group associated with the sTRP mode.

12. The UE of claim 8, wherein a TCI codepoint list of CCs of the group associated with the sDCI mTRP mode corresponds to a permutation of all activated TCI states from all CORESET pool IDs of CCs of the group associated with the mDCI mTRP mode.

13. The UE of claim 2, wherein the first CC is associated with the sDCI mTRP mode.

14. The UE of claim 13, wherein the MAC-CE is associated with at least one predefined order identification (ID).

15. The UE of claim 14, wherein the apply further comprises apply the activated TCI state for the one or more CCs of the remaining CCs of the group associated with the sTRP mode, when the MAC CE is associated with the at least one order ID.

16. The UE of claim 14, wherein all activated TCI states associated with the predefined order ID for the first CC are applicable to the one or more CCs of the remaining CCs of the group associated with the sTRP mode.

17-18. (canceled)

19. The UE of claim 1, wherein:
the indication is included in downlink control information (DCI) ;
the plurality of TRP modes comprise a single TRP (sTRP) mode and a multiple TRP (mTRP) mode; and
the mTRP mode corresponds to a multiple downlink control information (mDCI) mTRP mode or a single DCI (sDCI) mTRP mode.

20. The UE of claim 19, wherein:
the first CC is associated with at least one of: the sTRP mode or the sDCI mTRP mode; and
the apply further comprises apply the activated TCI state for the one or more CCs of the remaining CCs of the group associated with at least one of: the sTRP mode or the sDCI mTRP mode.

21. The UE of claim 19, wherein:
the first CC is associated with the mDCI mTRP mode; and
the apply further comprises apply the activated TCI state for the one or more CCs of the remaining CCs of the group associated with the mDCI mTRP mode.

22-24. (canceled)

25. The UE of claim 19, wherein:
the receive further comprises receive the DCI carrying the indication of a TCI codepoint for the first CC associated with the mDCI mTRP mode; and
the TCI codepoint for the first CC corresponds to all TCI codepoints from each CORESET pool identification (ID) of the one or more CCs of the remaining CCs of the group associated with the mDCI mTRP mode.

26. A method for wireless communications by a user equipment (UE), comprising:
receiving a first signaling configuring the UE with transmission configuration indicator (TCI) states for a group of component carriers (CCs), wherein each CC of the group is associated with one of a plurality of transmission reception point (TRP) modes;
receiving an indication to activate one of the TCI states for a first CC of the group; and applying the activated TCI state for the first CC and one or more CCs of remaining CCs of the group, based on at least one of: a type of the indication or a TRP mode associated with the remaining CCs of the group, wherein the remaining CCs of the group comprise the CCs other than the first CC.

27-30. (canceled)
